(19) United States
(12) Patent Application Publication
(10) Pub. No.: US 2006/0045480 A1
(43) Pub. Date: Mar. 2, 2006

(54) Optical disc recording and reproducing apparatus

(75) Inventor: Yoichiro Tanaka, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/212,595

(22) Filed: Aug. 29, 2005

(30) Foreign Application Priority Data
Aug. 30, 2004 (JP) P2004-250695

(51) Int. Cl. H04N 5/781

(52) U.S. Cl. 386/83; 386/125

(57) ABSTRACT

In an optical disc recording and reproducing apparatus, when a time shift determining unit determines that a time shift reproduction is currently performed, a reservation determining unit determines whether or not there is a timer reservation in the next place. When it is determined that there is the timer reservation and a pre-time determining unit determines that the timer reservation is performed a prescribed time before a reserved time, a first reservation performing unit performs an operation of a record by the timer reservation. Then, after the recording by the timer reservation is finished, a time shift reproducing unit continuously performs the time shift reproduction without turning off a power. After the time shift reproduction is continuously performed, when there is a timer reservation, a second reservation performing unit performs recording by the timer reservation.

### BACKGROUND OF THE INVENTION

1. Field of the Invention

The present invention relates to an optical disc recording and reproducing apparatus that has a power-off and stand-by specification in which a timer reservation is not performed under a non power-off state and records/reproduces data on an optical disc.

2. Description of the Related Art

As conventionally known, an optical disc recording and reproducing apparatus such as a DVD (digital versatile disk) recorder has what is called a power-off and stand-by specification in which a timer reservation for reserving and recording a received television program is not performed under a non power-off state. Further, the optical disc recording and reproducing apparatus can record the television program that is currently received and display the recorded program from an arbitrary part within a recorded range even when the program is currently recorded. That is, in the optical disc recording and reproducing apparatus, even while the program is recorded in an optical disc by using a time shift reproducing function, the recorded program can be displayed from an arbitrary position within the recorded range.

FIG. 4 is a diagram showing a process of a time shift reproduction in time series in the conventional optical disc recording and reproducing apparatus. An explanation is given by referring to FIG. 4. When a play key is pressed at a time T1, a time shift reproduction is started. When a stop key is pressed at a time T2, a process returns to an ordinary mode. For instance, to start a record of a second television program on an optical disc by using the optical disc recording and reproducing apparatus while a first television program is watched through a television image receiver, and to start a reproduction of an image recorded during a recording operation with a delay of prescribed time, the play key is pressed at the time T1.

Thus, the second television program is reproduced with a time shift. Then, when the stop key is pressed at the time T2, the time shift reproduction is stopped to return the process to the ordinary mode.

### SUMMARY OF THE INVENTION

However, the conventional optical disc recording and reproducing apparatus cannot perform a timer reservation during a time shift reproduction.

In a related art disclosed in JP-A-2003-169263, when an image is recorded while a time shift reproduction is performed, if a user sends an instruction for watching and listening to a television program, a tuner that is not related to an image recording operation is automatically selected without interrupting the image recording operation. Thus, the television program can be watched and listened to. However, this related art concerns a television image receiver in which a hard disk drive is incorporated and does not concern a time shift reproduction process and a timer reservation process in an optical disc recording and reproducing apparatus.

Another related art disclosed in t JP-A-2004-140625 concerns an image reservation and recording system and an image reservation and recording device for a hard disk recorder that can perform an image reservation and record even while a power is turned on and does not concern a time shift reproduction process and a timer reservation process in an optical disc recording and reproducing apparatus.

The present invention is proposed to solve the above-described problems and it is an object of the present invention to provide an optical disc recording and reproducing apparatus in which a key operation for shifting a mode to a timer stand-by state during a time shift reproduction is eliminated so that a recording operation by a timer reservation can be simplified and maneuverability can be improved.

To achieve the above-described object, a first aspect of the invention provides an optical disc recording and reproducing apparatus that has a power-off and stand-by specification in which a timer reservation is not performed under a non power-off state and records/reproduces data on an optical disc, the optical disc recording and reproducing apparatus including: a system controller that has: time shift determining means for determining whether or not a time shift reproduction is being performed; reservation determining means for determining whether or not there is a timer reservation when it is determined that the time shift reproduction is being performed; pre-time determining means for determining whether or not the timer reservation is performed a prescribed time before a reserved time when it is determined that there is the timer reservation; first reservation performing means for performing recording by the timer reservation when it is determined that the timer reservation is performed the prescribed time before the reserved time; time shift reproducing means for continuously performing the time shift reproduction without turning off a power after the recording by the timer reservation is finished; and second reservation performing means for performing a record by a timer reservation when there is the timer reservation after the time shift reproduction is continuously performed.

In this structure, when the time shift determining means determines that the time shift reproduction is being performed, the reservation determining means determines whether or not there is a timer reservation in the next place. When it is determined that there is the timer reservation and the pre-time determining means determines that the timer reservation is performed a prescribed time before the reserved time, the first reservation performing means performs an operation of the record by the timer reservation. Then, after the record by the timer reservation is finished, the time shift reproducing means continuously performs the time shift reproduction without turning off a power. After the time shift reproduction is continuously performed, when there is a timer reservation, the second reservation performing means performs an operation of a record by the timer reservation.

According to this structure, a timer stand-by key does not need to be assigned to shift to a timer stand-by state in which a power is turned off to start a timer reservation during the time shift reproduction. Thus, a key operation for shifting a mode to the timer stand-by state is not necessary. Accordingly, a recording operation by the timer reservation can be simplified, so that maneuverability for a user is improved.

A second aspect of the invention provides an optical disc recording and reproducing apparatus that has a power-off and stand-by specification in which a timer reservation is not performed under a non power-off state and records/reproduces data on an optical disc, the optical disc recording and reproducing apparatus including: a system controller for controlling to continuously perform a time shift reproduction without turning off a power after recording by a first timer reservation is finished when there is the first timer reservation during performing the time shift reproduction, and then, to perform recording by a second timer reservation when there is the second timer reservation after that.

In this structure, when there is the timer reservation during performing the time shift reproduction, after the record by the timer reservation is finished, the time shift reproduction is continuously performed without turning off the power. Then, when the timer reservation is present, the record by the timer reservation is performed.

According to this structure, a timer stand-by key does not need to be assigned to shift to a timer stand-by state in which a power is turned off to start a timer reservation during the time shift reproduction. Thus, a key operation for shifting a mode to the timer stand-by state is not necessary. Accordingly, a recording operation by the timer reservation can be simplified, so that maneuverability for a user is improved.

According to a third aspect of the invention, the system controller includes: a time shift determining unit for determining whether or not the time shift reproduction is being performed; a reservation determining unit for determining whether or not there is the first timer reservation when it is determined that the time shift reproduction is being performed; a pre-time determining unit for determining whether or not the first timer reservation is performed a prescribed time before a reserved time when it is determined that there is the first timer reservation; a first reservation performing unit for performing recording by the first timer reservation when it is determined that the first timer reservation is performed the prescribed time before the reserved time; a time shift reproducing unit for continuously performing the time shift reproduction without turning off a power after the recording by the first timer reservation is finished; and a second reservation performing unit for performing recording by the second timer reservation when there is the second timer reservation after the time shift reproduction is continuously performed.

As described above, according to the present invention, the system controller includes the time shift determining unit for deciding whether or not a time shift reproduction is being performed; the reservation determining unit for deciding whether or not there is a timer reservation when it is determined that the time shift reproduction is being performed; the pre-time determining unit for deciding whether or not the timer reservation is performed a prescribed time before a reserved time when it is determined that there is the timer reservation; the first reservation performing unit for performing a record by the timer reservation when it is determined that the timer reservation is performed the prescribed time before the reserved time; the time shift reproducing unit for continuously performing the time shift reproduction without turning off a power after the record by the timer reservation is finished; and the second reservation performing unit for performing a record by a timer reservation when there is the timer reservation after the time shift reproduction is continuously performed. Accordingly, a timer stand-by key does not need to be assigned to shift to a timer stand-by state in which a power is turned off to start a timer reservation during the time shift reproduction. Thus, a key operation for shifting a mode to the timer stand-by state is not necessary. Accordingly, a recording operation by the timer reservation can be simplified, so that maneuverability for a user is improved.

Further, according to the present invention, the system controller is provided for controlling to continuously perform a time shift reproduction without turning off a power after a record by a timer reservation is finished when there is the timer reservation during performing the time shift reproduction, and then, to perform a record by a timer reservation when there is the timer reservation after that. According to this structure, a timer stand-by key does not need to be assigned to shift to a timer stand-by state in which a power is turned off to start a timer reservation during the time shift reproduction. Thus, a key operation for shifting a mode to the timer stand-by state is not necessary. Accordingly, a recording operation by the timer reservation can be simplified, so that maneuverability for a user is improved.

### BRIEF DESCRIPTION OF THE DRAWINGS

FIG. 1 is a block diagram showing the structure of an optical disc recording and reproducing apparatus according to one embodiment of the present invention;

FIG. 2 is a flowchart for explaining processes for executing a timer reservation in this embodiment;

FIG. 3 is a diagram showing processes in time series when there is a timer reservation during a time shift reproduction in this embodiment; and

FIG. 4 is a diagram showing processes of a time shift reproduction in time series in a conventional optical disc recording and reproducing apparatus.

### DETAILED DESCRIPTION OF THE PREFERRED EMBODIMENTS

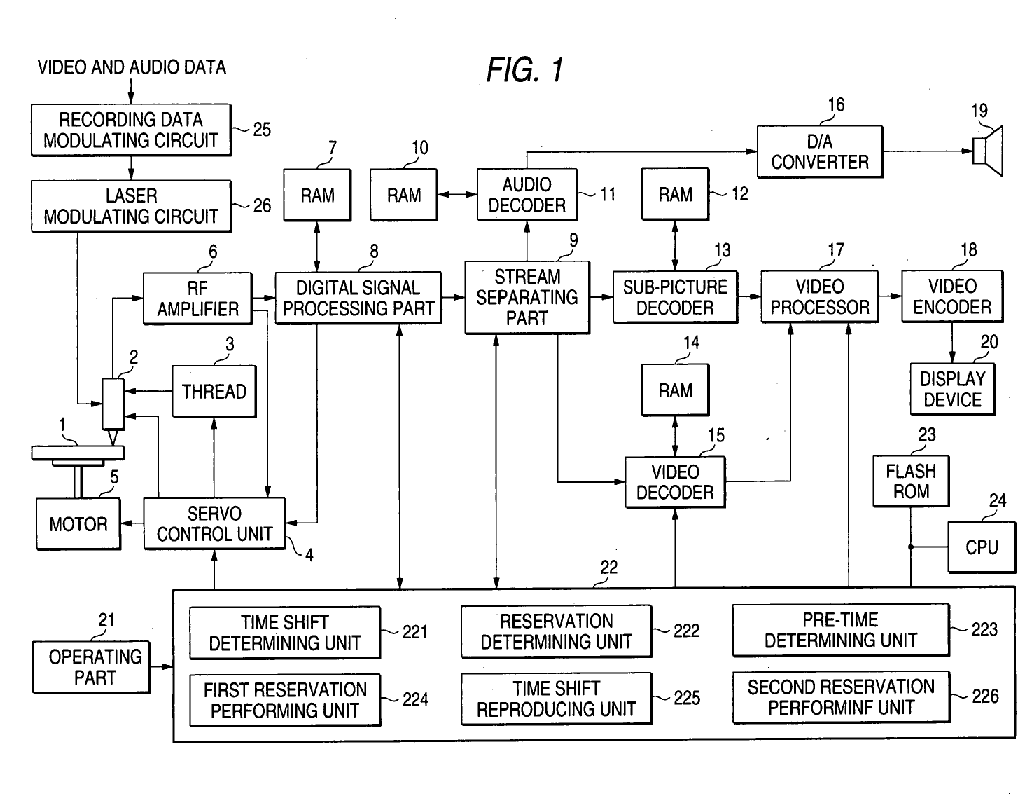

Now, referring to the accompanying drawings, an embodiment of the present invention will be described. FIG. 1 is a block diagram showing the structure of an optical disc recording and reproducing apparatus according to one embodiment of the present invention.

The optical disc recording and reproducing apparatus includes a spindle motor 5 for rotating an optical disc 1, an optical pick-up 2 for outputting a laser beam for reproducing information recorded on the optical disc 1 and receiving reflected light from the optical disc 1, a thread 3 for moving the optical pick-up 2 in the radial direction of the optical disc 1, and a servo control part 4 for controlling, in accordance with an instruction of a system controller 22, to drive the spindle motor 5 and the thread 3, to move an objective lens (not shown in the drawing) incorporated in the optical pick-up 2 and to move the focal position of the laser beam in the vertical direction and in the horizontal direction relative to the recording surface of the optical disc 1.

Further, the optical disc recording and reproducing apparatus includes an RF amplifier 6 for amplifying an RF signal as a reading signal from the optical pick-up 2 upon reproducing information on the optical disc 1, a digital signal processing part 8 for converting the RF signal outputted from the RF amplifier 6 to digital data, and then storing data formed by performing a signal demodulating process and an error correcting process in accordance with the data format of the optical disc 1 in a RAM 7 and a stream separating part 9 for separating audio data, sub-picture data and video data from a data stream outputted from the digital signal processing part 8 in accordance with the instruction of the system controller 22.

Further, the optical disc recording and reproducing apparatus includes an audio decoder 11 for inputting the audio data outputted from the stream separating part 9 to perform a prescribed decoding process, a RAM 10 for temporarily storing the data to perform the decoding process in the audio decoder 11, a sub-picture decoder 13 for inputting the sub-picture data outputted from the stream separating part 9 to perform a prescribed decoding process, a RAM 12 for temporarily storing the data to perform the decoding process in the sub-picture decoder 13, a video decoder 15 for inputting the video data outputted from the stream separating part 9 to perform a prescribed decoding process and a RAM 14 for temporarily storing the data to perform the decoding process in the video decoder 15.

Further, the optical disc recording and reproducing apparatus includes a video processor 17 for synthesizing the data outputted from the video decoder 15 with the data outputted from the sub-picture decoder 13 in accordance with the instruction of the system controller 22, a video encoder 18 for converting synthesized data outputted from the video processor 17 to a displaying video signal to display an image on a display device 20 and a D/A converter 16 for converting the data outputted from the audio decoder 11 to an analog audio signal and supplying the audio signal to, for instance, a speaker 19.

Further, the optical disc recording and reproducing apparatus includes an operating part 21 having a play key (not shown in the drawing) for giving an instruction for a reproduction to the system controller 22, a stop key (not shown in the drawing) for instructing a reproduction and a stop and various kinds of other operating keys and the system controller 22 for controlling the entire part of the device. The operating part 21 may be a remote controller or an operating part provided in the operating panel of a device main body.

Further, the optical disc recording and reproducing apparatus includes a flash ROM 23 in which a program or data for controlling respective component elements of the device and the entire part of the device is stored and a CPU 24 for performing a calculating process in according with the program or data of the flash ROM 23 to control the system controller 22.

Further, the optical disc recording and reproducing apparatus includes a recording data modulating circuit 25 for performing a modulating process to record on the optical disc 1 video and audio data transmitted from a television receiver or a personal computer that is not shown in the drawing and a laser modulating circuit 26 for outputting a laser modulating signal for modulating the laser beam outputted from the optical pick-up 2 on the basis of the data modulated by the recording data modulating circuit 25 to the optical pick-up 2.

The system controller 22 includes, as characteristic component elements of this embodiment, a time shift determining unit 221 for deciding whether or not a time shift reproduction is being performed; a reservation determining unit 222 for deciding whether or not there is a timer reservation when it is determined that the time shift reproduction is being performed; a pre-time determining unit 223 for deciding whether or not the timer reservation is performed a prescribed time before a reserved time when it is determined that there is the timer reservation; a first reservation performing unit 224 for performing a record by the timer reservation when it is determined that the timer reservation is performed the prescribed time before the reserved time; a time shift reproducing unit 225 for continuously performing the time shift reproduction without turning off a power after the record by the timer reservation is finished; and a second reservation performing unit 226 for performing a record by a timer reservation when there is the timer reservation after the time shift reproduction is continuously performed.

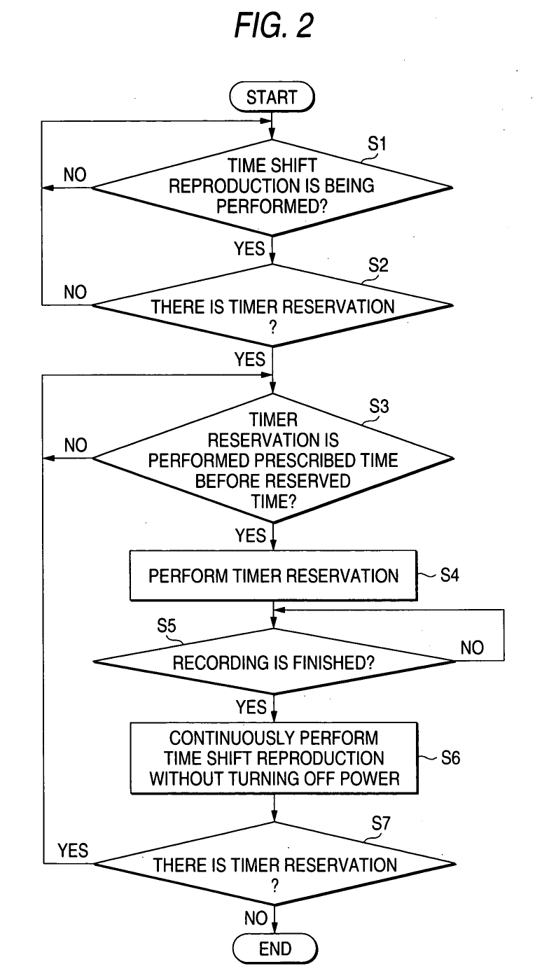

FIG. 2 is a flowchart for explaining an executing process of a timer reservation in this embodiment. The executing process of the timer reservation will be described by referring to this flowchart.

When the time shift determining unit 221 of the system controller 22 determines that the time shift reproduction is being performed (step S1), the reservation determining unit 222 then determines whether or not there is a timer reservation (step S2). For instance, when a flag showing whether or not the time shift reproduction is being performed represents logic 1, the time shift reproduction is being performed. When the flag represents logic 0, the flag shows that the time shift reproduction is not being performed. Accordingly, when the time shift determining unit 221 detects the flag showing the logic 1, the time shift determining unit 221 determines that the time shift reproduction is being performed (step S1). Further, reservation information showing that the timer reservation is present is stored in the flash ROM 23. Thus, the reservation determining unit 222 reads the reservation information from the flash ROM 23 to determine that there is the timer reservation (step S2).

Then, when it is determined that there is the timer reservation, the pre-time determining unit 223 determines whether or not the timer reservation is performed a prescribed time before the reserved time (for instance, when the reserved time is 9:30, if the prescribed time is two minutes, the time the prescribed time before the reserved time is 28 minutes past nine)(step S3). When it is the prescribed time before the reserved time, the first reservation performing unit 224 performs the record by the timer reservation (step S4). The prescribed time is required for the optical pick-up 2 to seek a target area on the optical disc 1 for performing the record by the timer reservation.

When the record by the timer reservation is finished (step S5), the time shift reproducing unit 225 continuously performs the time shift reproduction without turning off a power (step S6). Then, when there is the timer reservation (step S7), the procedure returns to the step S3 to subsequently perform the same processes. When there is not a timer reservation, the processes related to the timer reservation are finished.

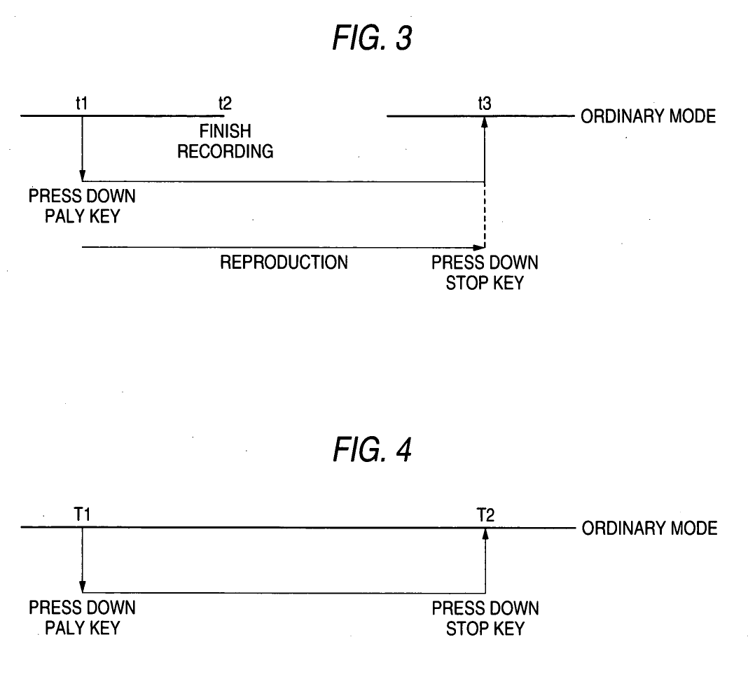

FIG. 3 is a diagram showing processes in time series when here is a timer reservation during the time shift reproduction in this embodiment. An explanation will be given below by referring to FIG. 3. When there is a timer reservation at a time t3 during the time shift reproduction, the play key is pressed down at a time t1 to shift to the time shift reproduction. At this time, during the time shift reproduction, even when the record is finished at a time t2, if the reproduction is still continuously performed, the stop key is pressed down at the time t3 to stop the time shift reproduction. A record by the timer reservation is started instead thereof. The contents of the record can be displayed on the display device 20.

As described above, according to this embodiment, the system controller 22 is provided for controlling to continuously perform the time shift reproduction without turning off a power after the record by the timer reservation is finished when there is the timer reservation during performing the time shift reproduction, and then, to perform the record by the timer reservation when there is the timer reservation after that. Accordingly, a timer stand-by key does not need to be assigned to shift to a timer stand-by state in which a power is turned off to start a timer reservation during the time shift reproduction. Thus, a key operation for shifting a mode to the timer stand-by state is not necessary. Accordingly, a recording operation by the timer reservation can be simplified, so that maneuverability for a user is improved.

What is claimed is:

1. An optical disc recording and reproducing apparatus that has a power-off and stand-by specification in which a timer reservation is not performed under a non power-off state and records/reproduces data on an optical disc, the optical disc recording and reproducing apparatus comprising:
a system controller that comprises:
time shift determining means for determining whether or not a time shift reproduction is being performed;
reservation determining means for determining whether or not there is a timer reservation when it is determined that the time shift reproduction is being performed;
pre-time determining means for determining whether or not the timer reservation is performed a prescribed time before a reserved time when it is determined that there is the timer reservation;
first reservation performing means for performing recording by the timer reservation when it is determined that the timer reservation is performed the prescribed time before the reserved time;
time shift reproducing means for continuously performing the time shift reproduction without turning off a power after the recording by the timer reservation is finished; and
second reservation performing means for performing a record by a timer reservation when there is the timer reservation after the time shift reproduction is continuously performed.

2. An optical disc recording and reproducing apparatus that has a power-off and stand-by specification in which a timer reservation is not performed under a non power-off state and records/reproduces data on an optical disc, the optical disc recording and reproducing apparatus comprising:
a system controller for controlling to continuously perform a time shift reproduction without turning off a power after recording by a first timer reservation is finished when there is the first timer reservation during performing the time shift reproduction, and then, to perform recording by a second timer reservation when there is the second timer reservation after that.

3. The optical disc recording and reproducing apparatus according to claim 2, wherein the system controller comprises:
a time shift determining unit for determining whether or not the time shift reproduction is being performed;
a reservation determining unit for determining whether or not there is the first timer reservation when it is determined that the time shift reproduction is being performed;
a pre-time determining unit for determining whether or not the first timer reservation is performed a prescribed time before a reserved time when it is determined that there is the first timer reservation;
a first reservation performing unit for performing recording by the first timer reservation when it is determined that the first timer reservation is performed the prescribed time before the reserved time;
a time shift reproducing unit for continuously performing the time shift reproduction without turning off a power after the recording by the first timer reservation is finished; and
a second reservation performing unit for performing recording by the second timer reservation when there is the second timer reservation after the time shift reproduction is continuously performed.
